(19) United States
(12) Patent Application Publication
(10) Pub. No.: US 2008/0204940 A1
(43) Pub. Date: Aug. 28, 2008

(54) Recording medium drive and latch member for recording medium drive

(75) Inventor: Kazunori Akama, Kawasaki-shi (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 12/002,923

(22) Filed: Dec. 19, 2007

(30) Foreign Application Priority Data
Feb. 26, 2007 (JP) 2007-44846

(51) Int. Cl. G11B 5/33

(52) U.S. Cl. 360/256.4

(57) ABSTRACT

This recording medium drive has an actuator member which rotationally moves around a first shaft, a latch stop member fixed to the housing, and a latch member which rotationally moves around a second shaft. The actuator member, having a locked member, and the latch member has a locking member which restrains the rotational movement of the actuator member and a coefficient of repulsion between the latch stop member and the latch member is a coefficient of repulsion such that, in the event that the housing receives an impact when the actuator is in a standby state, the locking member of the latch member reaches a lockable rotation angle before the locked member of the actuator member reaches the lockable rotation angle. In the event that various impacts are applied, it is possible to prevent the actuator member from jumping out to the recording medium.

The present invention relates to a recording medium drive such as a hard disk drive. More particularly, it relates to a latch member which restrains a rotation of an actuator member of a recording medium drive having a ramp member, in response to an impact.

### BACKGROUND OF THE INVENTION

Presently, for example, in a hard disk drive, a magnetic recording medium rotates at a high speed. Then, air is sucked in between a head slider and the magnetic recording medium, and the head slider is levitated by means of a pressure applied by the air. At this time, a magnetic head positioned at a leading end of the head slider maintains a distance from the magnetic recording medium at 20 nm or less. Then, the magnetic head carries out a reading and writing of medium information.

There is a contact start and stop (CSS) method which causes the head slider to make contact with a non-recording area of the magnetic recording medium and stand still during a non-operation of the hard disk drive. In this case, there is a problem in that, the head slider sticks to the magnetic recording medium somewhat, and sometimes stable levitation cannot be obtained again, or a problem in that the magnetic recording medium is damaged due to an impact. Therefore, today, a so-called loading and unloading method which receives a loading tab of the magnetic head assembly by means of a ramp member during the non-operation has been employed in many cases.

Meanwhile, a high impact resistance is required in a hard disk drive of 2.5 inches or less, used for a notebook computer and portable audio equipment, and a hard disk drive loaded in a vehicle. Particularly, in a hard disk drive employing the loading and unloading method, an actuator member withdraws from the ramp member onto the magnetic recording medium due to a rotational impact such as a dropping impact. Then, in the same way as described heretofore, it happens that the stack of the head slider to the magnetic recording medium, or the damage to the magnetic recording medium due to an impact, occurs.

As a related art, a latch member employing a mechanical locking mechanism using a force of inertia has been used. This is for solving the heretofore described problem. FIG. 1 shows a schematic view of an internal structure of a hard disk drive. A latch member 1 is fixed to a housing 14 in such a way as to be pivotable about a second shaft 4. In the same way, an actuator member 7 is fixed to the housing 14 in such a way as to be pivotable about a vertical support shaft 8. On receiving a rotational impact, the latch member 1 rotates in synchronization with the actuator member 7. Then, a locked member 9 of the actuator member 7 and a locking member 3 of the latch member 1 lock together. Then, the latch member 1 restrains the rotation of the actuator member 7. Consequently, the latch member 1 prevents a head slider 17, fixed to a leading end of the actuator member 7 through a suspension 16, from withdrawing from a ramp member 18 to a magnetic recording medium 13.

Herein, FIG. 2 shows impact waveforms of the latch member 1 and the actuator member 7, shown in FIG. 1, during an application of a dropping impact. A horizontal axis shows a time elapsed (ms) after receiving the dropping impact. A vertical axis shows an angle acceleration (Krad/s²) of the latch member 1 and the actuator member 7. A curved line 1a and a curved line 1b show impact waveforms when the latch member 1 moves to a position in which it locks the actuator member 7. A curved line 7a and a curved line 7b show impact waveforms when the actuator member 7 moves to a position in which it is locked by the latch member 1. Also, the curved line 1a and the curved line 7a show impact waveforms in a case of setting an impact application time at 0.2 msec. The curved line 1b and the curved line 7b show impact waveforms in a case of setting the impact application time at 0.8 msec.

The actuator member 7 is in contact with an actuator stop member 11 made of, for example, rubber. The latch member 1 is in contact with a latch stop member 6 made of, for example, a metal. In this way, the actuator member 7 and the latch member 1 are in contact with materials differing in a coefficient of repulsion. As the impact is absorbed by the materials differing in the coefficient of repulsion, mutually different angle accelerations are transmitted from the drive. This means that the difference in the angle accelerations is more noticeable in a case of applying the impact for the impact application time of 0.2 msec than in a case of applying the impact for the impact application time of 0.8 msec. That is, it can be said that more greatly differing angle accelerations are transmitted in a case of impacting against a hard article than in a case of impacting against a soft article.

However, in order that the latch member 1 locks the actuator member 7, that the angle accelerations of the actuator member 7 and the latch member 1 should be about the same regardless of the time elapsed after the application of the impact. That is, that the impact waveforms of the latch member 1 and the actuator member 7 should be about the same.

The coefficient of repulsion between the actuator member 7 and the actuator stop member 11 is made to have the same value as the coefficient of repulsion between the latch member 1 and the latch stop member 6. By so doing, the impact is transmitted under the same conditions. Consequently, a swinging of the actuator member 7 and a swinging of the latch member 1 constantly maintain the same timing.

Consequently, the present invention has an object of providing a latch member in which, in the event that a rotational impact is applied to the drive, the same angle acceleration is transmitted from the drive to the latch member and the actuator member.

### SUMMARY OF THE INVENTION

In accordance with an aspect of an embodiment, a recording medium drive includes a housing, a recording medium, a first shaft and a second shaft which are fixed to the housing, an actuator member which rotationally moves around the first shaft, and a head fixed to one end of the actuator which moves over the recording medium in an approximately radial direction. A latch stop member is fixed to the housing; and a latch member rotationally moves around the second shaft. The actuator member has a locked member and the latch member has a locking member which restrains the rotational movement of the actuator member. A coefficient of repulsion between the latch stop member and the latch member is a coefficient of repulsion such that, in the event that the housing receives an impact, the locking member of the latch member reaches a lockable rotation angle before the locked member of the actuator member reaches the lockable rotation angle.

### BRIEF DESCRIPTION OF THE DRAWINGS

The present invention will be explained with reference to the accompanying drawings.

FIG. 1 shows a schematic view of an internal structure of a heretofore known hard disk drive;

FIG. 2 shows impact waveforms of a heretofore known latch member and actuator member during an application of a dropping impact;

FIG. 3 shows a schematic view of an internal structure of a hard disk drive of the present invention;

FIG. 4 shows a side view of an actuator member and a latch member of the present invention;

FIG. 5 shows another side view of the actuator member and the latch member of the present invention;

FIG. 6A shows a side view taken from a left side of FIG. 6B;

FIG. 6B shows a plan view of a latch member of a first embodiment of the latch member according to the invention, as seen from a direction of a second shaft;

FIG. 6C shows a side view taken from a right side of FIG. 6B;

FIG. 7A shows a side view taken from a left side of FIG. 7B;

FIG. 7B shows a plan view of a latch member of a second embodiment of the latch member according to the invention, as seen from the direction of the second shaft;

FIG. 7C shows a side view taken from a right side of FIG. 7B;

FIG. 8A shows a side view taken from a left side of FIG. 8B;

FIG. 8B shows a plan view of a latch member of a third embodiment of the latch member according to the invention, as seen from the direction of the second shaft;

FIG. 8C shows a side view taken from a right side of FIG. 8B; and

FIG. 9 shows impact waveforms of the latch member of the third embodiment and the actuator member during an application of a dropping impact.

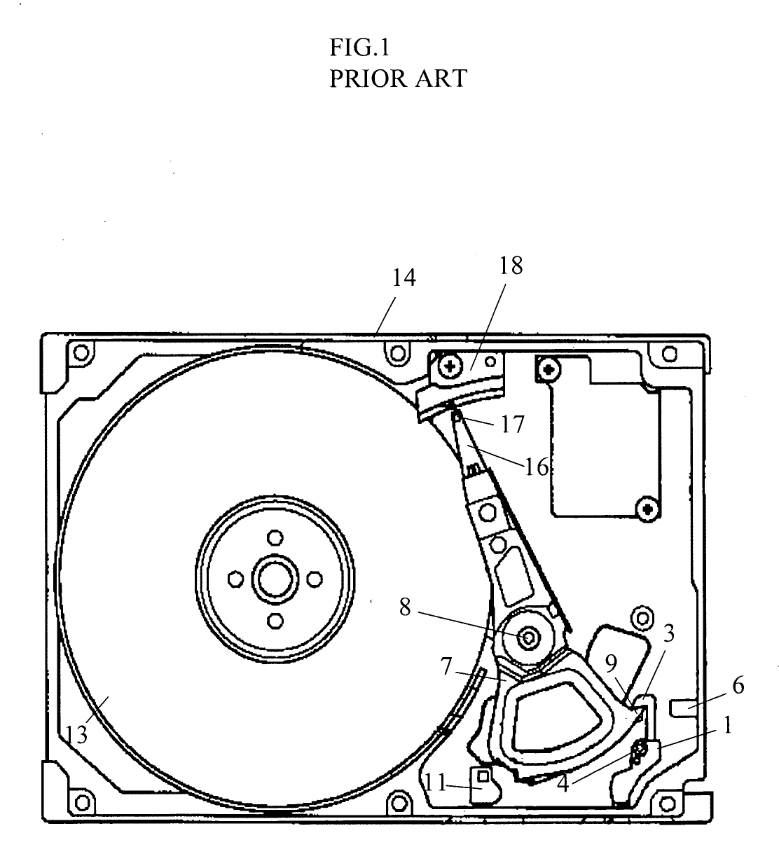

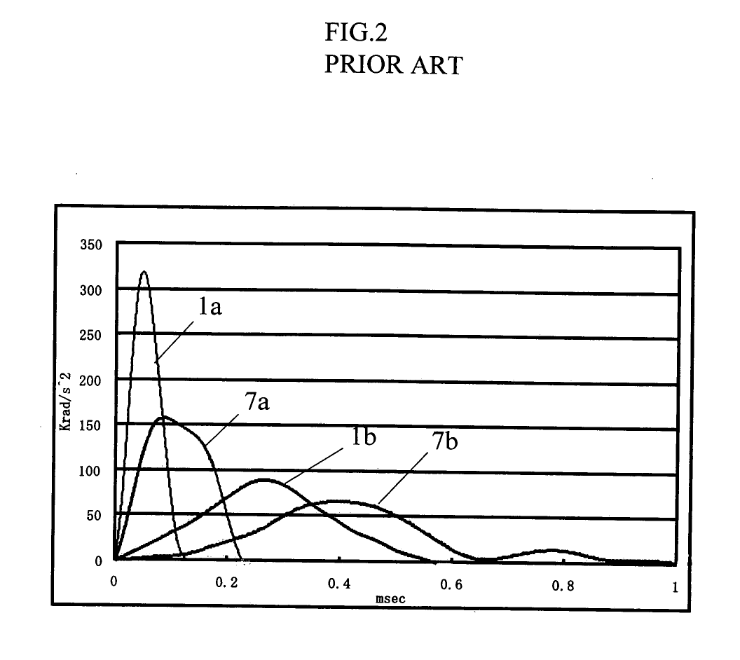

### DETAILED DESCRIPTION

Hereafter, a detailed description will be given of embodiments of the invention, based on the accompanying drawings.

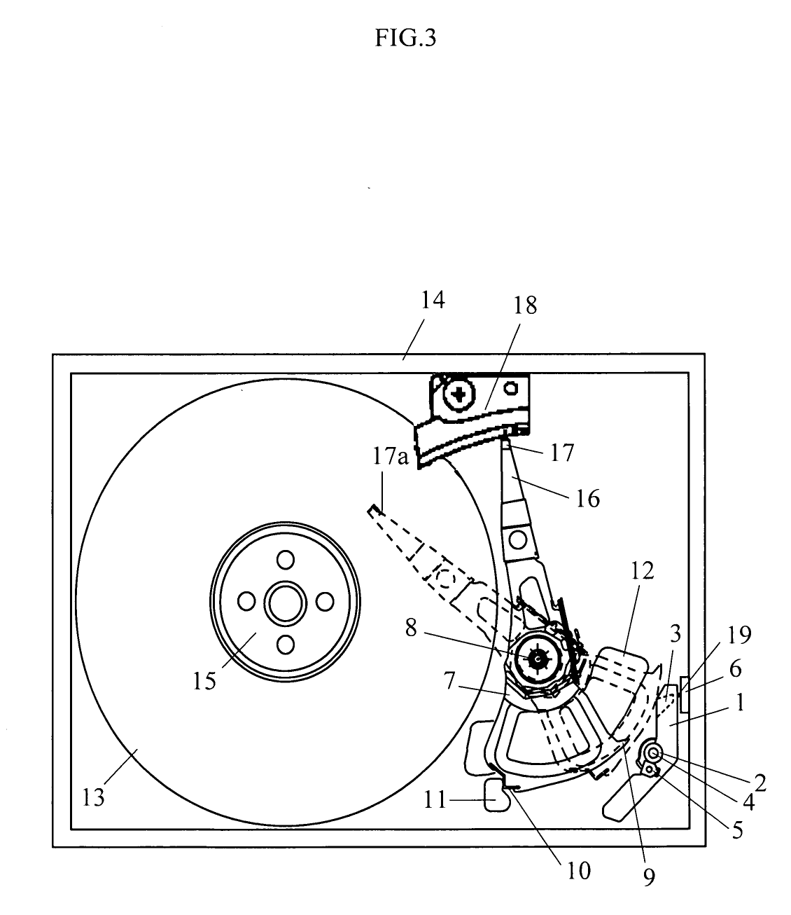

FIG. 3 shows a schematic view of an internal structure of a hard disk drive as a recording medium drive according to the invention. The hard disk drive includes a magnetic recording medium 13 and a head slider 17 inside a box-shaped housing 14 made of a metal such as Al.

The magnetic recording medium 13 is attached to a rotary shaft of a spindle motor 15. The magnetic recording medium 13 rotates at a high speed of 5400 rpm, 7200 rpm or more. A suspension 16 made of a flexible stainless steel is attached to one end of an actuator member 7. The head slider 17 loaded with a magnetic head is attached beneath the suspension 16. A head suspension assembly is configured of the head slider 17 and the suspension 16.

The actuator member 7 is rotatably fixed to the housing 14 by a vertical support shaft 8. The actuator member 7 moves in an approximately radial direction of the magnetic recording medium 13. By this means, the head slider 17 attached to the suspension 16 moves over the magnetic recording medium 13 in the approximately radial direction. As shown by a position 17a delineated by a broken line, the head slider 17 carries out a recording/reproduction of information on a predetermined track.

Also, a ramp member 18 is fixed to the housing 14. During a non-operation of the hard disk drive, i.e., a parked or standby state, a loading tab attached to a leading end of the suspension 16 is supported by the ramp member 18. In this way, the head slider 17 levitated over the magnetic recording medium 13 is caused to withdraw from over the magnetic recording medium 13. Regarding a starting time of a magnetic disk device, after the magnetic recording medium 13 has reached a predetermined revolution speed, by pivoting the actuator member 7, the head slider 17 is loaded over the magnetic recording medium 13 at a predetermined speed. Meanwhile, regarding a stopping time of the magnetic disk device, in the case in which the magnetic recording medium 13 reaches the predetermined revolution speed, the head slider 17 is unloaded from over the magnetic recording medium 13 to the ramp member 18 at the predetermined speed. The ramp member 18 is molded from, for example, a hard plastic material.

Furthermore, a latch member 1 is fixed to the housing 14 in such a way as to be pivotable around a second shaft 4. In the event that a rotational impact is applied, along with the rotation of the actuator member 7, the latch member 1 also rotates at the same angle acceleration. These rotations become synchronous, and a locked member 9 of the actuator member 7 and a locking member 3 of the latch member 1 lock together. Then, the rotation of the actuator member 7 is restrained. Consequently, it does not happen that the actuator member 7 rotates and withdraws to the magnetic recording medium 13. It is also acceptable that the locking member 3 is of a notched shape as long as it locks the locked member 9 of the actuator member 7.

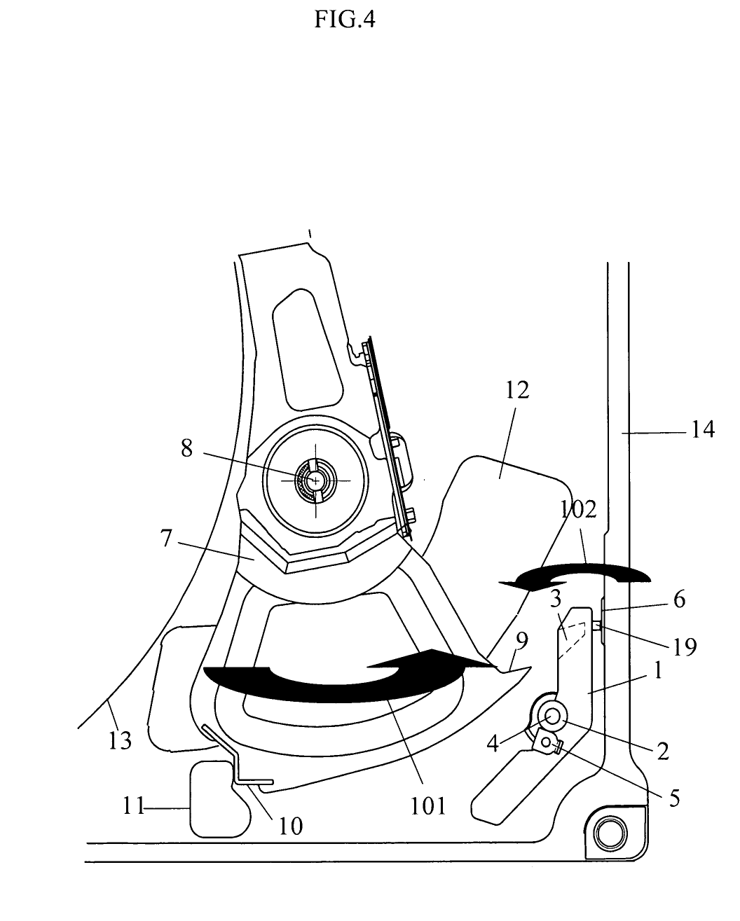

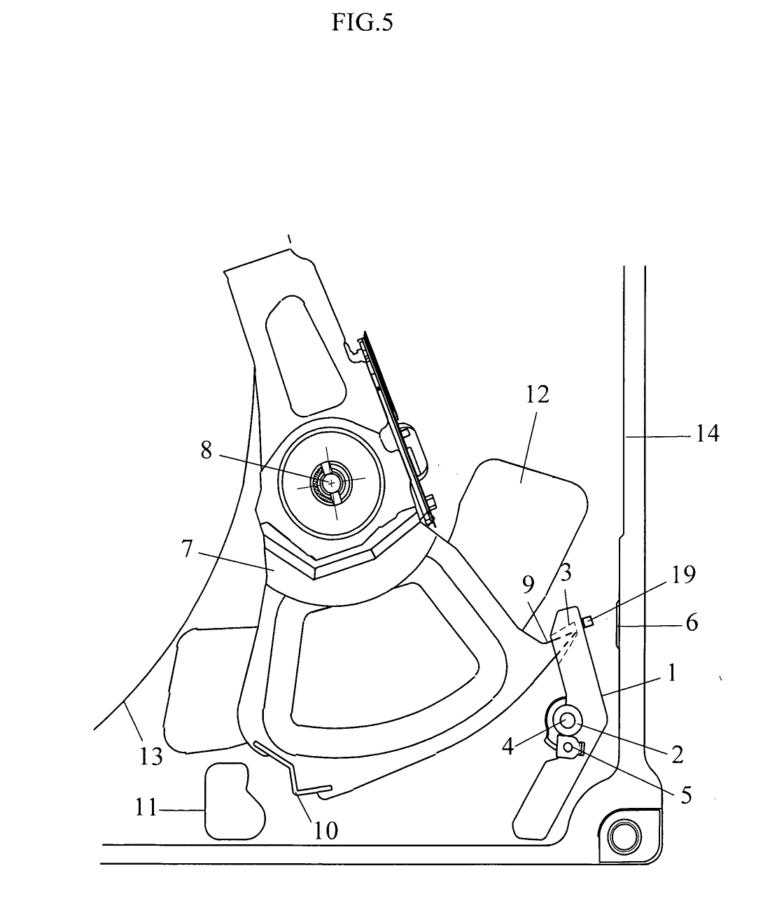

FIGS. 4 and 5 show schematic views of conditions before and after the locking of the actuator member and the latching member according to the invention. Let us assume a case in which a clockwise rotational impact is applied to the drive. Due to a force of inertia, the actuator member 7 and the latch member 1 receive the same angle accelerations 101 and 102. The latch member 1 rotates around the second shaft 4. As a result, as shown in FIG. 5, the latch member 1 rotates to a position in which it restrains the rotation of the actuator member 7. Then, the locking member 3 of the latch member 1 locks the locked member 9 of the actuator member 7. Herein, magnetic gravitations are applied to the actuator member 7 and the latch member 1 in accordance with their weights. By this means, the actuator member 7 and the latch member 1 generate the same angle acceleration with respect to the rotational impact. Specifically, a metal piece 10 fixed to the actuator member 7 and a metal piece 5 fixed to the latch member 1 are attracted toward a permanent magnet 12 for swinging the actuator member 7, by means of its magnetic gravitation.

Consequently, during the non-operation of the hard disk drive, a contact of the metal piece 10 fixed to the actuator member 7 with a rubber actuator stop member 11 is maintained by means of the magnetic gravitation. Also, even in the event that a certain impact is applied to the hard disk drive, it does not happen that the actuator member 7 withdraws from the ramp member. However, during an operation of the hard disk drive, it being necessary to swing the actuator member 7, it is not possible to make a size of the magnetic gravitation greater than necessary. Consequently, in order to cause the swinging of the actuator member 7, a magnetic force is set in such a way that a torque of the motor has a value of an effective range. For this reason, in the event that a greater impact than the magnetic gravitation is applied, the withdrawal is prevented by the locking of the actuator member 7 and the latch member 1.

Next, let us consider a case of FIG. 5 in which a counterclockwise rotational impact is applied to the drive. Angle accelerations rotating clockwise are each applied to the actuator member 7 and the latch member 1. The actuator member 7 is in contact with the rubber actuator stop member 11. The latch member 1 is in contact with an aluminum latch stop member 6. Consequently, the actuator member 7 and the latch member 1 receive a force of repulsion from the actuator stop member 11 and the latch stop member 6, and their rotation direction changes to a counterclockwise one.

However, as will be described hereafter, the latch member 1 of the invention adjusts a coefficient of repulsion in accordance with a volume and shape of a portion of contact thereof with the latch stop member 6. A coefficient of repulsion between the actuator member 7 and the actuator stop member 11 is approximately equal to that between the latch member 1 and the latch stop member 6. Then, the same angle acceleration is transmitted to the latch member 1 and the actuator member 7.

Consequently, even in the event that various impacts are applied to the drive, the swinging of the actuator member 7 is synchronized with a swinging of the latch member 1. The locked member 9 of the actuator member 7 and the locking member 3 of the latch member 1 lock together. In this way, as the rotation of the actuator member is restrained, it does not happen that the actuator member withdraws from the ramp member 18.

Also, it is possible to form the latch member 1 from a single material. Consequently, the invention has an advantageous effect on mass productivity and production costs, too. The same applies to a first embodiment, a second embodiment and a third embodiment which will be shown hereafter.

In the event that no impact is applied, the metal piece 10 fixed to the actuator member 7 maintains the contact with the actuator stop member 11 made of rubber. This is caused by the magnetic gravitation between the metal piece 10 and the permanent magnet 12. Meanwhile, the metal piece 5 fixed to the latch member 1 also maintains the contact with the latch stop member 6. This is caused by the magnetic gravitation between the metal piece 5 and the permanent magnet 12. The sizes of these magnetic gravitations are made to have values proportional to the weights of the actuator member 7 and the latch member 1. By so doing, it is possible to make the angle accelerations equal in the event that the coefficients of repulsion are equal.

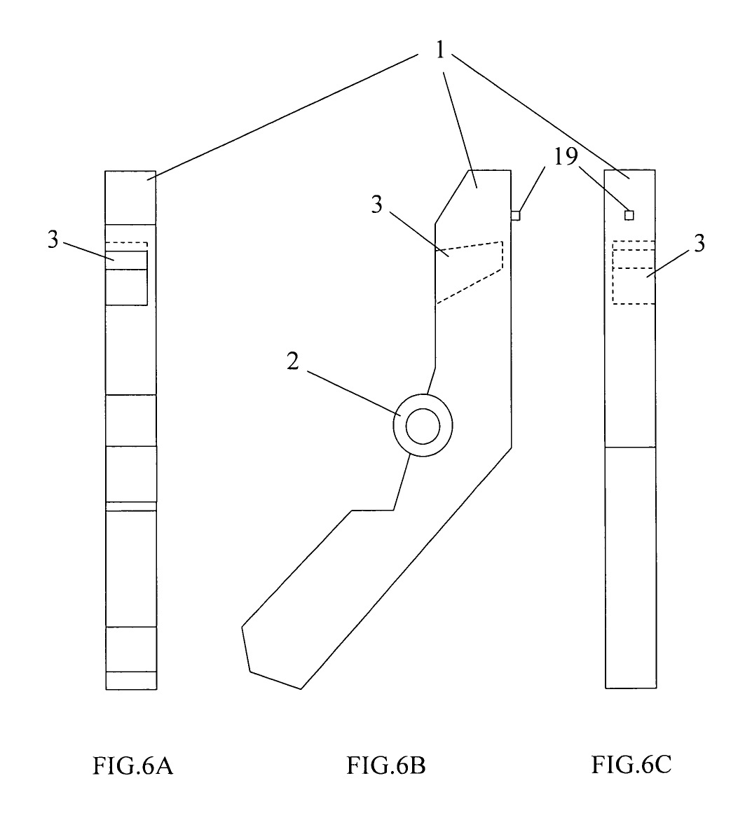

Next, FIGS. 6A to 6C show a configuration of the first embodiment of the latch member according to the invention. FIG. 6B is a plan view of the latch member 1 according to the first embodiment, as seen from a direction of the second shaft. FIGS. 6A and 6C are side views taken from left and right sides of FIG. 6B, respectively. A contact protrusion member 19 is formed on a surface of contact of the latch member 1 with the latch stop member. The contact protrusion member 19 is configured of the same material as that of the latch member 1. The invention has a structure in which only the contact protrusion member 19 makes contact with the latch stop member.

In the first embodiment, the latch member 1 is in contact with the latch stop member via the contact protrusion member 19. A volume of the latch member 1 in a vicinity of the contact portion is smaller than that of the heretofore known latch member. Consequently, in the event that the impact is received, as the contact protrusion member 19 is distorted, the coefficient of repulsion between the latch member 1 and the latch stop member is high. That is, by adjusting a volume of the contact protrusion member 19, the coefficient of repulsion between the actuator member and the actuator stop member is made equal to that between the latch member 1 and the latch stop member. By so doing, in the event that the drive receives the rotational impact, the actuator member and the latch member 1 receive the same angle acceleration and rotate. As a result, the locked member of the actuator member and the locking member 3 of the latch member 1 locking together, it is possible to restrain the rotation of the actuator member.

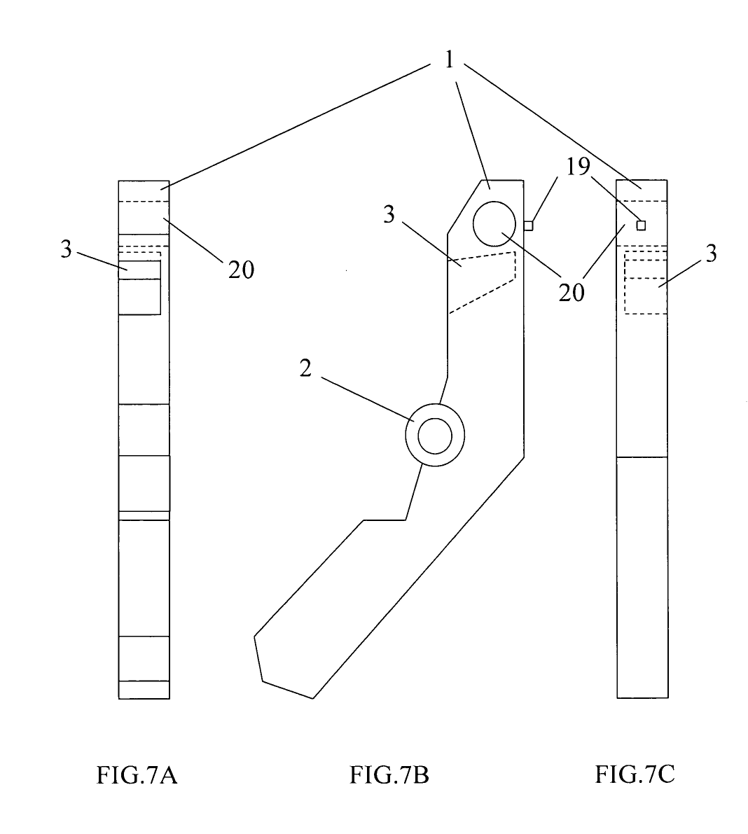

Next, FIGS. 7A to 7C show a configuration of the second embodiment of the latch member according to the invention. FIG. 7B is a plan view of the latch member according to the second embodiment, as seen from the direction of the second shaft. FIGS. 7A and 7C are side views taken from left and right sides of FIG. 7B, respectively. The contact protrusion member 19 is formed on the surface of contact of the latch member 1 with the latch stop member. Furthermore, a penetration hole 20 is formed in the latch member 1. By the penetration hole 20 being formed, regarding a thickness in the rotation direction of the latch member 1, a portion of connection thereof with the contact protrusion member 19 is thinner than a portion other than the connection portion.

In comparison with the first embodiment, in the second embodiment, the latch member 1 is thinner in a vicinity of the protrusion member. Consequently, in the event that the impact is received, as the contact protrusion member 19 is distorted, and the latch member 1 is flexed, the coefficient of repulsion between the latch member 1 and the latch stop member becomes high. That is, by adjusting the volume of the contact protrusion member 19 and the thickness of the latch member 1 in the vicinity of the protrusion member, the coefficient of repulsion between the actuator member and the actuator stop member is made equal to that between the latch member 1 and the latch stop member. By so doing, in the event that the drive receives the rotational impact, the actuator member and the latch member 1 receive the same angle acceleration and rotate. As a result, the locked member of the actuator member and the locking member 3 of the latch member 1 locking together, it is possible to restrain the rotation of the actuator member. The penetration hole 20 not being limited to a circular shape, it is sufficient that it has a shape which reduces an elastic coefficient when a force is applied thereto from the protrusion member. It is also acceptable that it penetrates in, for example, a polygon such as a quadrangle, or a sector form.

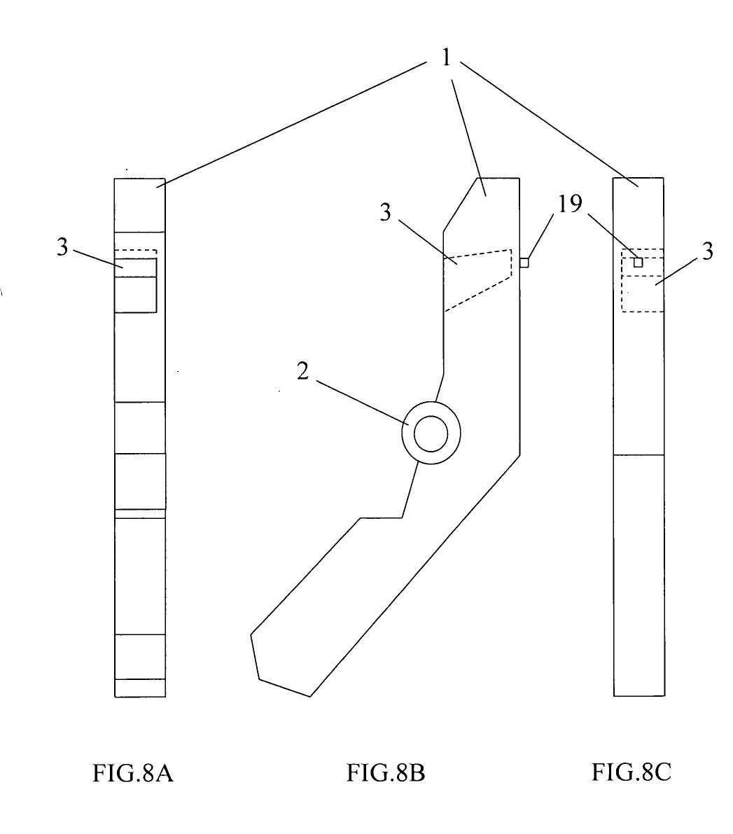

Next, FIGS. 8A to 8C show a configuration of the third embodiment of the latch member according to the invention. FIG. 8B is a plan view of the latch member 1 according to the third embodiment, as seen from the direction of the second shaft. FIGS. 8A and 8C are side views taken from left and right sides of FIG. 8B, respectively. The contact protrusion member 19 is formed on the surface of contact of the latch member 1 with the latch stop member. Furthermore, the locking member 3 is formed in the latch member 1. By the locking member 3 being formed, regarding the thickness in the rotation direction of the latch member 1, the portion of connection thereof with the contact protrusion member 19 is thinner than the portion other than the connection portion. Also, the locking member 3 also doubles as a structure in which it locks the locked member of the actuator member when receiving the rotational impact.

In comparison with the first embodiment, in the third embodiment, the latch member 1 is thinner in the vicinity of the protrusion member. Consequently, in the event that the impact is received, as the contact protrusion member 19 is distorted, and the latch member 1 is flexed, the coefficient of repulsion between the latch member 1 and the latch stop member becomes high. That is, by adjusting the volume of the contact protrusion member 19, and the thickness of the latch member 1 in the vicinity of the protrusion member, the coefficient of repulsion between the actuator member and the actuator stop member is made equal to that between the latch member 1 and the latch stop member. By so doing, in the event that the drive receives the rotational impact, the actuator member and the latch member 1 receive the same angle acceleration and rotate. As a result, the locked member of the actuator member and the locking member 3 of the latch member 1 locking together, it is possible to restrain the rotation of the actuator member. Furthermore, by the locking member 3 locking the locked member of the actuator member, it is also possible to reliably carry out the restraint of the rotation of the actuator member.

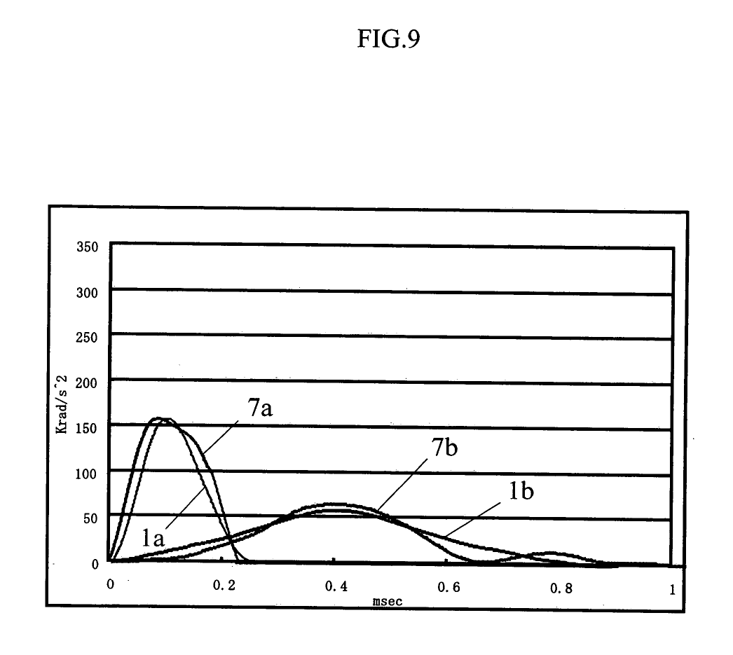

FIG. 9 shows impact waveforms of the latch member 1 and the actuator member, shown in FIGS. 8A to 8C, during an application of a dropping impact. A horizontal axis shows a time elapsed (ms) after receiving the dropping impact. A vertical axis shows the angle acceleration (Krad/s²) of the actuator member and the latch member. A curved line 1a and a curved line 1b show impact waveforms when the latch member 1 moves to the position in which it locks the actuator member 7. A curved line 7a and a curved line 7b show impact waveforms when the actuator member 7 moves to the position in which it is locked by the latch member 1. Also, the curved line 1a and the curved line 7a show impact waveforms in a case of setting an impact application time at 0.2 msec. The curved line 1b and the curved line 7b show impact waveforms in a case of setting the impact application time at 0.8 msec. The impact waveform of the latch member 1 is approximately equal to that of the actuator member. In this way, it is possible to adjust the coefficients of repulsion in accordance with the shape of the latch member 1 and the volume of the contact portion.

By using the structure of the latch member 1 of the invention, it is possible to adjust the coefficients of repulsion so as to be approximately equal. Then, the same angle acceleration is transmitted to the actuator member and the latch member 1. Consequently, the actuator member and the latch member 1 rotate synchronously in response to the various rotational impacts. As the latch member 1 rotates to the position in which it restrains the rotation of the actuator member, and locks the actuator member, it is possible to prevent the actuator member from withdrawing onto the magnetic recording medium.

According to the latch member for the recording medium drive of the invention, even in the event that the various impacts are applied, the same angle acceleration is transmitted from the drive to the actuator member and the latch member. Then, it is possible to prevent the actuator member from jumping out to the recording medium. Consequently, it is possible to provide a recording medium drive which is superior in impact resistance and lower in price.

What is claimed is:

1. A recording medium drive comprising: a housing; a recording medium; a first shaft and a second shaft which are fixed to the housing; an actuator member which rotationally moves around the first shaft; a head fixed to one end of the actuator member such that the head moves over the recording medium in an approximately radial direction; a latch stop member fixed to the housing; and a latch member which rotationally moves around the second shaft, wherein
the actuator member, has a locked member, and
the latch member has a locking member, which engages the locked member and restrains the rotational movement of the actuator member when the drive is in a standby position and is subjected to a sufficient impact, and a contact protrusion member, which makes contact with the latch stop member in a standby position and is not subjected to sufficient impact.

2. The recording medium drive according to claim 1, wherein
a thickness in a rotation direction of a portion of connection of the latch member with the contact protrusion member is smaller than that of a portion other than the portion of contact of the latch member with the contact protrusion member.

3. The recording medium drive according to claim 2, wherein
the latch member has a cavity, and the thickness in the rotation direction of the portion of connection of the latch member with the contact protrusion member is smaller than that of the portion other than the portion of connection of the latch member with the contact protrusion member adjacent the cavity.

4. The recording medium drive according to claim 3, wherein
the cavity of the latch member is the locking member.

5. A recording medium drive comprising: a housing; a recording medium; a first shaft and a second shaft which are fixed to the housing; an actuator member which rotationally moves around the first shaft; a head fixed to one end of the actuator member such that the head moves over the recording medium in an approximately radial direction; a latch stop member fixed to the housing; and a latch member which rotationally moves around the second shaft, wherein
the actuator member, has a locked member, and
the latch member has a locking member, which engages the locked member and restrains the rotational movement of the actuator member, and
a coefficient of repulsion between the latch stop member and the latch member is a coefficient of repulsion such that, in the event that the housing receives an impact, the locking member of the latch member reaches a lockable rotation angle before the locked member of the actuator member reaches the lockable rotation angle.

6. The recording medium drive according to claim 5, wherein
the latch member is configured of a single material.

7. The recording medium drive according to claim 5, wherein
the latch member has a contact protrusion member, and
the latch stop member makes contact with the latch member via the contact protrusion member.

8. The recording medium drive according to claim 6, wherein
the latch member has a contact protrusion member, and
the latch stop member makes contact with the latch member via the contact protrusion member.

9. The recording medium drive according to claim 7, wherein
a thickness in a rotation direction of a portion of connection of the latch member with the contact protrusion member is smaller than that of a portion other than the portion of contact of the latch member with the contact protrusion member.

10. The recording medium drive according to claim 8, wherein
a thickness in a rotation direction of a portion of connection of the latch member with the contact protrusion member is smaller than that of a portion other than the portion of contact of the latch member with the contact protrusion member.

11. The recording medium drive according to claim 9, wherein
the latch member has a cavity, and the thickness in the rotation direction of the portion of connection of the latch member with the contact protrusion member is smaller than that of the portion other than the portion of connection of the latch member with the contact protrusion member adjacent the cavity.

12. The recording medium drive according to claim 10, wherein
the latch member has a cavity, and the thickness in the rotation direction of the portion of connection of the latch member with the contact protrusion member is smaller than that of the portion other than the portion of connection of the latch member with the contact protrusion member adjacent the cavity.

13. The recording medium drive according to claim 11, wherein
the cavity of the latch member is the locking member.

14. The recording medium drive according to claim 12, wherein
the cavity of the latch member is the locking member.

15. A latch member moving around a shaft comprising:
a shaft bearing, and a contact protrusion member, wherein
a thickness in a rotation direction of a portion of connection of the latch member with the contact protrusion member is smaller than that of a portion other than the portion of contact of the latch member with the contact protrusion member.

16. The latch member according to claim 15, wherein
the latch member has a cavity, and the thickness in the rotation direction of the portion of connection of the latch member with the contact protrusion member is smaller than that of the portion other than the portion of connection of the latch member with the contact protrusion member adjacent the cavity.

17. The recording medium drive according to claim 16, wherein
the cavity of the latch member is the locking member.
